(19) United States
(12) Patent Application Publication
(10) Pub. No.: US 2018/0206459 A1
(43) Pub. Date: Jul. 26, 2018

(54) CATCH MONITORING SYSTEMS AND METHODS

(71) Applicants: Stephen C. Crawford, Pass Christian, MS (US); John Eli Underhill, Gulfport, MS (US); Ryan Robert Elliott, Santa Ynez, CA (US)

(72) Inventors: Stephen C. Crawford, Pass Christian, MS (US); John Eli Underhill, Gulfport, MS (US); Ryan Robert Elliott, Santa Ynez, CA (US)

(21) Appl. No.: 15/876,601

(22) Filed: Jan. 22, 2018

Related U.S. Application Data
(60) Provisional application No. 62/450,706, filed on Jan. 26, 2017.

(51) Int. Cl. A01K 61/90; H04Q 9/00; A01M 23/00; A01K 69/06; A01K 29/00

(52) U.S. Cl. CPC A01K 61/90; H04Q 9/00; H04Q 2209/40; A01K 69/06; A01K 29/00; A01M 23/00

(57) ABSTRACT

Traps are monitored for catch, by-catch, and environmental conditions. A catch sensor is configured to detect a catch of animals or marine life caught in a trap. An environmental sensor is configured to sense an environmental condition associated with a location of the trap. A trap monitor is configured to collect and transmit catch data indicative of the detected catch and environmental data indicated of the environmental condition to a communications subsystem for distribution to a remote device or a device in close proximity to the communications subsystem.

### TECHNICAL FIELD

The present invention relates to trap monitoring. More specifically, the present invention relates to remotely monitoring traps for catch data and other data and distributing such data.

### BACKGROUND

Monitoring traps for caught animals and/or marine life is typically a cumbersome task that must be performed manually. Manual inspection of traps wastes time, fuel, and money.

Systems have been proposed for remotely monitoring traps for caught animals and traps or pots for caught fish. However, such systems are limited in the information that they provide.

It is, therefore, a goal of the invention described herein to provide a device, method, and system for monitoring catching of animals and/or marine life in traps from a remote location while providing additional data which may be useful to, for example, professional and recreational trappers and fisherman, the scientific community, and wildlife/fishing management agencies.

### SUMMARY

The present embodiments relate to systems and methods for monitoring traps. At least one catch sensor is configured to detect a catch of animals or marine life caught in at least one trap. At least one environmental sensor is configured to sense an environmental condition associated with a location of the trap. A trap monitor is configured to collect and transmit catch data indicative of the detected catch and environmental data indicative of the sensed environmental condition to a communications subsystem for distribution to at least one of a remote device and a device in close proximity to the communications subsystem.

### BRIEF DESCRIPTION OF SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s) in which:

FIG. 1 illustrates a catch monitoring system according to illustrative embodiments.

FIG. 2 depicts a flow chart showing steps involved in a method for monitoring traps according to illustrative embodiments.

FIG. 3 depicts a flow chart showing steps involved in a method for collecting and distributing catch data and environmental data according to illustrative embodiments.

### DETAILED DESCRIPTION

According to illustrative embodiment, catch monitoring systems and methods allow for remote monitoring of traps for catches of animals and/or marine life. The present embodiments relate to methods and systems for monitoring traps to count the animals/marine life that enter a trap and allow remote, live access to the actual count data. Additional information may also be provided remotely, such as environmental data and by-catch data. Remote data access will allow the determination of active fishing or trapping areas faster so that resources can be efficiently moved to the active areas. Data for remotely connected devices may be used by, for example, members of the fishing industry, the trapping industry, the scientific community, and wildlife/fisheries management agencies.

For illustrative purposes, the description that follows focuses on a catch monitoring system for marine life. However, it should be appreciated that similar systems and methods may be used to monitor traps for animals other than marine life. It should further be appreciated that the terminology “trap” as used herein includes a pot or any other device capable of trapping marine life or an animal.

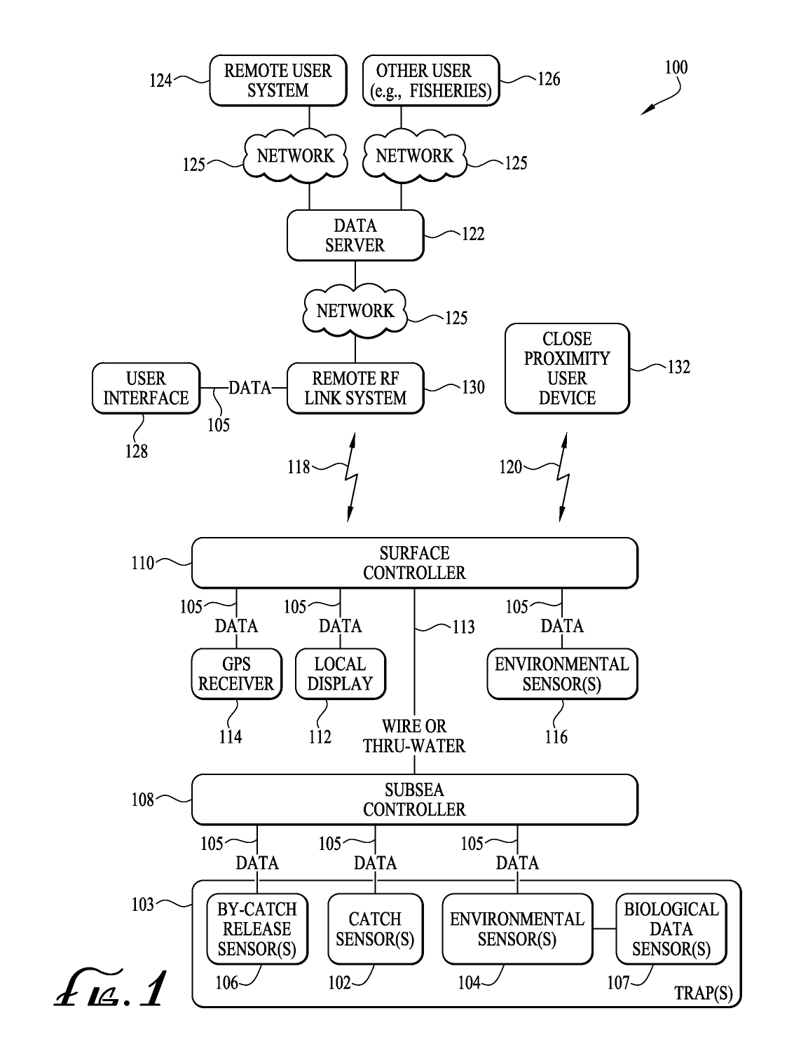

Referring to FIG. 1, a catch monitoring system 100 is shown which monitors the capture of marine life. The system 100 includes a submerged subsurface system, including a subsea controller 108 (also referred to herein as a trap monitor), and a surface system, including a surface controller 110 (also referred to herein as a communications subsystem). The surface system may be integrated with or attached to, for example, a buoy.

The subsea controller 108 communicates with catch sensor(s) 102, environmental sensor(s) 104, and by-catch sensor(s) 106 via, for example, wired or wireless data links 105. Each catch sensor 102 and by-catch sensor 106 may be associated with an individual trap. Each environmental sensor may be associated with a location of an individual trap. The traps are collectively represented in FIG. 1 as traps 103. The subsea controller 108 may be integrated as part of a trap or may be separate from the trap. Each catch sensor 102 and by-catch sensor 106 may be integrated as part of an associated trap or connected to the trap. Each environmental sensor 104 may be integrated as part of a trap or placed at a location of the trap.

Each catch sensor 102 includes a trigger that determines when marine life, such as a crab or lobster, enters the trap. According to one embodiment, when set off, the trigger included in the corresponding catch sensor increments a catch count, which is communicated to the subsea controller 108. Similarly, each by-catch sensor 106 may include a trigger that is set off in response to a bycatch releasing opening. When the trigger included in the by-catch sensor 106 is set off, the by-catch sensor decrements the catch count, which is communicated to the subsea controller 108.

As an alternative to the catch sensor 102 incrementing a catch count and the catch sensor 102 may communicate information indicative of detected catches to the subsea controller, and the subsea controller 108 may increment the catch count, accordingly. For example, the catch sensor 102 may communicate information indicating each individual catch to the subsea controller. This information may be sent as part of a package of data including a time and environmental conditions sensed at the time of the catch (described in further detail below).

Similarly, the by-catch sensor 106 may communicate information indicative of detected by-catches to the subsea controller, and the subsea controller 108 may decrement the catch count, accordingly. For example, the by-catch sensor 106 may communicate information indicating each release of by-catch to the subsea controller. This information may be sent as part of a package of data including a time and environmental conditions sensed at the time of the release (described in further detail below).

The triggers associated with the catch sensor(s) 102 and the by-catch sensor(s) 106 may include any mechanical switch, magnetic switch, optical switch, ultrasonic switch, contactless radio frequency switch, or magnetic loop type switch. The trigger that is used may vary from species to species and vary with trap size.

Simple on-off type switches generally consume the least power and require little programming. Triggers not requiring sealing around a moving actuator are preferred to minimize leak paths (failure points). Contactless detection of movement through the trap opening may be preferred for larger opening traps and traps where the marine life may not push through a contact when feeling resistance.

Ultrasonic distance sensors or electrical field change monitors can also be used in the catch sensor(s) 102 to determine the volume of the catch in the traps for situations or target species for which a trigger is not feasible.

Each trap may also be associated with one or more environmental sensors 104 for sensing various environmental conditions at the locations of the traps. Examples of environmental conditions that may be sensed include temperature, depth, salinity, light level, sound velocity, conductivity, images and/or video, current speed and direction, etc.

Although not shown, a camera and/or microphone may be connected to each trap to record video/audio data indicative of activity within and around the trap. Further, a timer may be connected to or incorporated within each trap or sensor, such that a timestamp or time period may be associated with one or more detected catches, releases, and environmental conditions.

Each trap may further be associated with one or more biological data sensors 107 for sensing a biological condition of animals or marine life entering the trap, caught by the trap, and/or surrounding the trap. These sensors may include, for example, density sensors that detect density within the trap. This may be useful in determining the sex of the catch.

For example, radio signals may be sent through coils in a trap to measure the density. If there is something in the trap, a radio signal will be reflected which will be indicative of the density of the catch. As the weight and size of different genders of marine life vary, the gender of the catch may be determined based on the detected density. This determination may be made, e.g., by the subsea controller 108, by correlating the detected density with known weights and sizes of genders of marine life.

As an alternative to density sensors, the biological data sensors 107 may include, for example, ultrasonic detectors, video pattern recognition detectors, or other detectors capable of determining the sex or other significant biological data associated the marine life entering the trap, caught in the trap, and/or surrounding the trap.

Each of the traps 103 communicates with a subsea controller 108, sending count increments, count decrements, environmental data and other data, e.g., video/audio data, and density data. Each of the traps 103 may include a transceiver for this purpose. This data may be collected from the traps 103 by the subsea controller 108 at regular intervals or in real time. Although one subsea controller 108 is shown for ease of explanation, it should be appreciated that each of the traps 103 may include a subsea controller 108 and/or multiple subsea controllers 108 may be used.

The subsea controller 108 may include a microprocessor or similar device to register catch counts, both incrementing and decrementing catch counts where needed, and package the data for transmission, along with the environmental data and any other collected data associated with the traps, to the surface controller 110. The subsea controller 108 may include a transceiver for communicating with the surface controller 110. Data may be sent by the subsea controller 108 at specified intervals, in real time, or in response to an interrogation from the surface controller 110. The subsea controller 108 may also include a transceiver for communicating with the traps 103.

A data transmission link 113 connects the subsea controller 108 to the surface controller 110. A simple wired link may be employed as the data transmission link for shallow and/or low-cost systems. This wired link transfers data through standard communication protocols (e.g., RS-232 or RS-485).

The wired link may also supply power from one unit to the other unit when one battery or power source is desired for both units. Thus, subsea controller 108 may be powered by a battery installed inside the unit, or power may be supplied from the surface controller 110.

Instead of a wired system, the data transmission link 113 may include a wireless through-water communication link, such as a radio frequency (RF) link, that allows the subsea controller 108 to communicate with the surface controller 110 without a physical connection. This may be desirable for deep water systems or to allow networked systems with multiple subsea units and one single surface unit.

An example of a networked system may include multiple subsea controllers 108, each associated with a plurality of traps 103 and each communicating with the respective associated traps and with a central subsea controller including one or more transceivers (not shown). The central subsea controller, in turn communicates with the surface controller 110.

The connection between the surface subsystem and the subsea system is also important for monitoring equipment. For example, if no signal is received by the surface controller 110 from a trap after a certain amount of time, this may be indication that a trap trigger has failed or the battery has run out.

The surface controller 110 may incorporate many features similar to the subsea controller 108. For example, the surface controller 110 may include a microprocessor and transceiver(s) for communicating with the subsea controller 108 and with remote locations (described in more detail below).

The surface controller 110 receives data from the subsea controller 108, including the count data, environmental conditions data, and other data that may be associated with the traps. Once the data is available at the surface, it may be used locally and/or transmitted to a remote location. Local data access allows the trap owner/operator complete control of the data on the trap status. This may be preferred in competitive areas or may simply be a user preference.

In addition to the surface controller 110, the surface subsystem of the catch monitoring system 100 may include a local display 112. Received data may be recorded within a memory in the surface controller 110 and information representing the received data may be displayed directly on the local display 112.

The local display 112 may include a simple seven-segment LED array display turned on briefly or at set intervals to display the current count or to indicate when the counter reaches a pre-selected number. More complex displays may be utilized when required or desired.

The count data is useful for a variety of reasons, including enabling a fisherman to know when a trap is full, providing data for government reporting, etc. The count recorded may also be useful in determining whether to deploy a number of traps. For example, one or a few traps may be initially deployed in a given location. If the count of catch is low, indicating that the location is not good for catching, the traps may be moved to a different location.

Information on site-specific environmental conditions may also be useful in determining optimum trap placement. Long-term monitoring and recording of conditions allows characterization of the local area to determine seasonal changes that affect the effectiveness of traps in various locations. To that end, one or more environmental sensor(s) 116 may be included at the surface system. The environmental sensor(s) 116 sense, e.g., temperature, salinity, wave height and period, wind speed and direction, current speed and direction, barometric pressure, etc. The current speed and direction at the surface may be different than the current speed and direction at the location of the trap, and this information may be useful, e.g., for effectively covering the sea bottom with bait scent and/or a chum line to draw in a desired prey. Also, setting a trap and other gear 90° to the current direction provides maximum coverage, so it would be desirable to sense the current direction at the surface and at the sea bottom.

These environmental sensors may be connected to the surface controller 110 or may be placed on buoys that are in communication with the surface controller 110.

A GPS sensor 114 may be included in the surface subsystem to provide a general location of a catch or harvest, based on the location of the surface subsystem. In addition, the surface subsystem may include a location detector (not shown) that detects location signals sent from the traps. These location signals indicate precisely the locations of the traps, relative to the surface subsystem. The location data may be helpful in recovering stolen equipment as well as allowing mapping of the fishery status. The GPS sensor 114 and/or the location detector may be connected to the surface controller 110 or may be placed on buoys that are in communication with the surface controller 110.

The surface controller 110 may be remotely connected via a remote radio frequency (RF) communication link 118 to a remote RF link system 130. The remote RF link system 130 may include, for example, multiple radio transceivers and other input/output interfaces for receiving and transmitting data. Data received by the remote RF link system 130 may be transmitted via, for example, a communications network 125, to a central data server 122 and/or a remote user device. The communications network 125 may include a collection of servers operated by one or more service providers, such as the Internet, or any other suitable network of surface units communicating with each other with or without the use of a service provider, such as Inmarset. Data transmitted to the central data server 122 may be accessed by any authorized party, such as a user of a remote user device 124 or another user 126, e.g., a computer in a fishery. A user interface 128 may also be connected to the remote RF link system 130 via, for example, a data link 105.

Also, a local RF link 120 may be used to transmit data from the surface controller 110 to a user device 132 in close proximity to the surface controller 110, such as a cell phone or a computer on a nearby fishing vessel.

Count data, location data, environmental data, and other data collected by the surface controller 110 may be transmitted via the communication link 118 and/or the local RF link 120.

Data transmission throughout the system may be two-way, allowing a remote control and modification of parameters. For example, the surface controller 10 may communicate an instruction to the subsea controller 108 to modify a timing delay for a catch sensor 102 to eliminate false triggering. Also, faulty or unused components may be remotely turned off responsive to instructions from the surface controller 110 to save battery life.

Central collection of data by the data server 122 allows access to the data by the trap owner, scientists, and fisheries management via the communications network 125 and/or communication links to the data server 122 (which may be similar to the RF communication link 118). For example, a software interface to the data server 122 via the remote user device 124 would allow a trap owner with a large number of traps to check the status of the traps and environmental conditions remotely and determine trap deployment strategy to maximize the catch. Central collection also allows monitoring by scientific or fisheries management interests.

While the examples above are directed largely to counting and reporting organisms in submerged traps, it should be appreciated that the invention is not limited to capturing marine life.

Also, while not shown in detail, it should be appreciated that various components of the system, such as the subsea controller 108, the surface controller 110, and the data server 122 may each include input/output interfaces, transceivers, memory, and a processor configured to execute computer readable instructions stored in the memory along with other data. The memory may include a non-transitory computer readable medium implemented with volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that can be used to store information that can be accessed by the subsea controller 108, the surface controller 110, and the data server 122. It should further be appreciated that each of the subsea controller 108, the surface controller 110, and the data server 122 may include a combination of hardware and software in addition to, or instead of, a processor executing computer readable instructions stored in a memory.

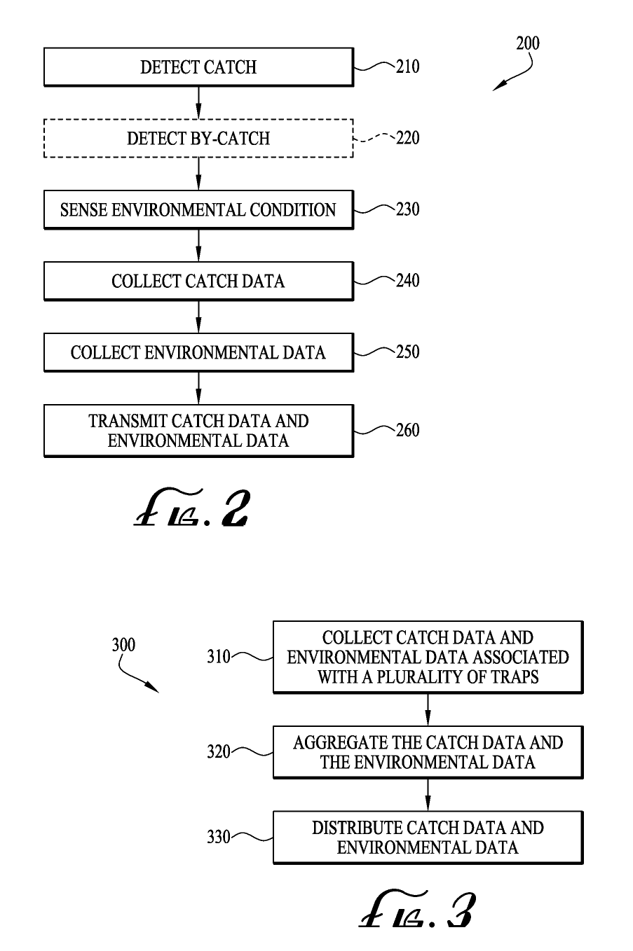

FIG. 2 depicts a flow chart showing steps involved in a method for monitoring traps according to illustrative embodiments. Referring to FIG. 2, the method 200 begins at step 210 at which a catch of an animal or marine life in a trap is detected, e.g., by the catch sensor 102. Optionally, at step 220, a by-catch is detected, e.g., by the by-catch release sensor 106. It should be appreciated that steps 210 and 220 may be repeated as animals or marine life are caught and by-catch is released.

At step 230, one or more environmental conditions are sensed. This step may be performed continuously, at regular intervals, and/or in response to an instruction from the subsea controller 108.

At step 240, the subsea controller 108 collects catch data indicative of the detected catch from one or more catch sensors 102. At step 270, the subsea controller 108 collects environmental data indicative of sensed environmental conditions from one or more environmental sensors 104.

At step 250, the subsea controller 108 transmits the catch data and the environmental data to the surface controller 110 for distribution to, for example remote user devices 124 and/or a device 132 in close proximity to the surface controller 110.

Although not shown in FIG. 2, it should be appreciated that steps may also be included to increment the catch count in response to detected catches and decrement the catch count in response to detected releases of by-catch. As described above, the catch count may be incremented by the catch sensors 102 or by the subsea controller 108. The catch count may be decremented by the by-catch sensors 106 of the subsea controller 108.

FIG. 3 depicts a flow chart showing steps involved in a method for collecting and distributing catch data and environmental data according to illustrative embodiments. Referring to FIG. 3, the method 300 begins at step 310 at which catch data and environmental data associated with a pliantly of traps is collected by, for example, the surface controller 110. The surface controller 110 may collect this data from one or more subsea controllers 108, each serving a plurality of traps. Alternatively, the surface controller 110 may collect this data from a central controller that is in communication with a network of subsea controllers. The surface controller 110 may collect this data as a result of one or more subsea controllers 108 sending the data at specified intervals or in real time. Alternatively, the surface controller 110 may collect this data on demand by interrogating one or more subsea controllers 108.

At step 320, the surface controller 110 aggregates the catch data and the environmental data. The surface controller 110 may also aggregate other data, e.g., environmental data indicative of environmental conditions sensed by one or more environmental seniors 116 and location data from the GPS receiver 114 and/or a location detector as described above.

At step 330, the surface controller 110 distributes the catch data and the environmental data to, for example, remote user devices 124 and/or a device 132 in close proximity to the surface canceller 110 as described above. The surface controller 110 may also distribute other data, e.g., environmental data indicative of sensed environmental conditions at the location of the surface controller 110, location data indicative of a location of the surface controller 110, and location data indicative of locations of the various traps.

It should be understood that the steps or other interactions of the illustrated methods are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims. It should also be understood that the method can be ended at any time. In certain embodiments, some or all steps of the method, and/or substantially equivalent steps can be performed by execution of computer-executable instructions stored or included on a non-transitory computer-readable medium.

While the various embodiments have been shown and described, it will further be apparent to those skilled in the art that many modifications, additions, and deletions can be made therein without departing from the spirit and scope of the invention as defined by the following claims.

1. A system for monitoring at least one trap, comprising:
a trap monitor;
at least one catch sensor associated with the trap and configured to detect a catch of animals or marine life caught in the trap; and
at least one environmental sensor configured to sense an environmental condition associated with a location of the trap,
wherein the trap monitor is configured to collect and transmit catch data indicative of the detected catch and environmental data indicative of the sensed environmental condition to a communications subsystem for distribution to at least one of a remote device and a device in close proximity to the communications subsystem.

2. The system of claim 1, wherein at least one of the catch sensor and the trap monitor is further configured to increment a catch count in response to a detected catch, and wherein the catch data is further indicative of the catch count.

3. The system of claim 2, wherein the system further comprises
a plurality of catch sensors, each catch sensor associated with one of a plurality of traps; and
a plurality of environmental sensors, each environmental sensor associated with a location of one of the plurality of traps,
wherein the trap monitor is further configured to collect and transmit the catch data associated with each of the plurality of traps and the environmental data indicative of the sensed environmental condition associated with the location of each of the plurality of traps to the communications subsystem.

4. The system of claim 1, further comprising:
a by-catch release sensor associated with the trap and configured to detect a release of by-catch from the trap, wherein at least one of the by-catch release sensor and the trap monitor is configured to decrement the catch count in response to a detected release.

5. The system of claim 1, wherein the trap is submerged underwater, and the environmental data indicative of an environmental condition associated with the location of the trap includes at least one of temperature, depth, salinity, light level, sound velocity, conductivity, images, video, current speed, and current direction.

6. The system of claim 1, wherein the communications subsystem is located at a water surface, and the trap monitor is submerged underwater.

7. The system of claim 1, further comprising at least one biological data sensor associated with the trap and configured to sense data indicative of a sex or other biological condition associated with an animal or marine life entering the trap, caught in the trap, or surrounding the trap.

8. A method for monitoring a trap, comprising:
detecting a catch of an animal or marine life in the trap;
sensing an environmental condition associated with a location of the trap,
collecting the catch data indicative of the detected catch;
collecting environmental data indicative of the sensed environmental condition; and
transmitting the catch data and the environmental data to a communications subsystem for distribution to at least one of a remote device and a device in close proximity to the communications subsystem.

9. The method of claim 8, further comprising
incrementing a catch count associated with the trap, wherein the catch data is further indicative of the catch count

10. The method of 9, wherein:
collecting the catch data includes collecting catch data associated with each one of a plurality of traps;
collecting the environmental data includes collecting environmental data indicative of a sensed environmental condition associated with a location of each of the plurality of traps;
transmitting the catch includes transmitting the catch data associated with each of the plurality of traps; and
transmitting the environmental data includes transmitting the environmental data indicative of the sensed environmental condition associated with the location of each of the plurality of traps.

11. The method of claim 8, further comprising:
detecting release of a by-catch from the trap; and
decrementing the catch count.

12. The method of claim 8, wherein the trap is submerged underwater, and the environmental data indicative of an environmental condition associated with the location of the trap includes at least one of temperature, depth, salinity, light level, sound velocity, conductivity, images, video, current speed, and current direction.

13. The method of claim 8, wherein the communications subsystem is located at a water surface.

14. The method of claim 8, further comprising sensing data indicative of a sex or other biological condition associated with an animal or marine life entering the trap, caught in the trap, or surrounding the trap.

15. A system for monitoring a plurality of traps, comprising:
a trap monitoring subsystem configured to collect catch data indicative of a catch of animals or marine life of each of the plurality of traps and environmental data indicative of an environmental condition associated with a location of each of the plurality of traps; and
a communications subsystem configured to aggregate the catch data and the environmental data collected by the trap monitoring subsystem and distribute the catch data and the environmental data to at least one of a remote device and a device in close proximity to the communications subsystem.

16. The system of claim 15, wherein the catch data is further indicative of by-catch that is released from the traps.

17. The system of claim 15, wherein the communications subsystem is further configured to present data for display that is indicative of at least one of the catch data and the environmental data.

18. The system of claim 15, wherein the catch data and the environmental data are distributed to the remote device via at least one of a remote communication link and a data server.

19. The system of claim 15, wherein the catch data and the environmental data are distributed to the device in close proximity to the communications subsystem via a local radio frequency link.

20. The system of claim 15, wherein at least some of the traps and the trap monitoring subsystem are submerged underwater.

21. The system of claim 15, wherein the communications subsystem is further configured to collect environmental data indicative of an environmental condition sensed at a location of the communications subsystem.

22. The system of claim 21, wherein the communications subsystem is located at a water surface, and the environmental data indicative of an environmental condition sensed at the location of the communications subsystem includes at least one of temperature, salinity, wave height and period, wind speed, wind direction, current speed, current direction, and barometric pressure.

23. The system of claim 15, wherein at least some of the traps are submerged underwater, and the environmental data indicative of an environmental condition associated with the location of each of the traps includes at least one of temperature, depth, salinity, light level, sound velocity, conductivity, images, video, current speed, and current direction.

24. The system of claim 15, wherein the trap monitoring subsystem includes:
a network of trap monitors, each trap monitor associated with a plurality of traps and each configured to collect the catch data and the environmental data from the associated plurality of traps; and
a central trap monitoring subsystem configured to collect the catch data and the environmental data collected by each of the plurality of trap monitors, and
wherein the communications subsystem is configured to aggregate the catch data and the environmental data from the central trap monitoring subsystem.
